(19) United States
(12) Patent Application Publication
(10) Pub. No.: US 2013/0140411 A1
(43) Pub. Date: Jun. 6, 2013

(54) Stand

(71) Applicant: Leica Microsystems (Schweiz) AG, Heerbrugg (CH)

(72) Inventor: Roman Frick, Speicher (CH)

(73) Assignee: LEICA MICROSYSTEMS (SCHWEIZ) AG, HEERBRUGG (CH)

(21) Appl. No.: 13/691,423

(22) Filed: Nov. 30, 2012

(30) Foreign Application Priority Data
Dec. 1, 2011 (DE) 102011119814.1

(51) Int. Cl. F16M 11/00

(52) U.S. Cl. CPC F16M 11/00
USPC 248/123.11; 248/125.1

(57) ABSTRACT

The invention relates to a stand, in particular to a stand for a surgical microscope, having a pivotable carrier arm (4) and having a microscope holder (6) pivotable in a plane at the distal end of the carrier arm (4), the angular position (21; 24) of the microscope holder (6) being definable with reference to the carrier arm (4), and having a motorized drive that engages on the one hand on the carrier arm and on the other hand on the microscope holder (6), and in the context of operation defines the angular position (21; 24) in remotely controlled fashion and/or automatically. This construction eliminates complex parallelogram supports and angle transfer elements that link the tilt of the microscope holder (6) depending on the pivot position of the carrier arm (4). The construction thus becomes simpler and lighter, and less dependent on production tolerances.

### CROSS REFERENCE TO RELATED APPLICATIONS

This application claims priority of German patent application number 10 2011 119 814.1 filed Dec. 1, 2011, the entire disclosure of which is incorporated by reference herein.

This application is also related to concurrently filed, co-pending, and commonly assigned application entitled “Stand,” bearing U.S. Ser. No. ______ and having internal reference number 033997.00189, claiming priority to German patent application number 10 2011 119 813.3 filed Dec. 1, 2011, the disclosures of which are hereby incorporated by reference in their entirety.

### FIELD OF THE INVENTION

The invention relates to a stand, in particular to a stand for a surgical microscope.

### BACKGROUND OF THE INVENTION

Stands, in particular the surgical stands used by specialists, were as a rule implemented with the aid of parallelogram supports before the type of the species was developed. The underlying theory is that with a parallelogram support, the load that is acting can be correctly positioned and held without bending. It is found in practice, however, that even parallelogram supports are subject to a certain bending. This is influenced differently by the weight of the load, however. In the case of a surgical microscope, the load is a surgical microscope having a very wide variety of accessories. Because the different accessories generally entail a different weight loading, a difference in the deflection of the carrier arm structure of course occurs. Because a microscope holder is as a rule mounted at the distal end of a known parallelogram support of this kind, the difference in bending results in a weight-dependent difference in the spatial positioning of the microscope holder, and thus in a weight-dependent spatial position of the surgical microscope. This in turn results, when an accessory change occurs on the surgical microscope, in a displacement of its optical main axis with reference the surgical site. This in turn leads, in some circumstances, to a need for readjustment of the surgical microscope and/or of the stand, although this is undesirable during a surgical procedure.

The problem alluded to above occurs because of the difference between ideal mathematically parallelogram designs and designs that are physically executed. Reference is made, as an example in the existing art, to a construction having the designation “Zeiss OPMI MD on NC1” (http://medeqipexp.com/Zeiss%20NC1-OPMI%20MD.htm). A solution to this problem that avoids readjustment is possible within certain limits only by corresponding stiffening of the parallelogram supports. This usually results, however, in an increased operating weight of the stand, which once again is undesirable.

A much greater problem occurs, however, with older stands that are not yet constructed according to the species: If the parallelogram support is braced on a single pivotable horizontal carrier arm as in the case of the indicated Zeiss OPMI MD on NC1 construction, pivoting of that carrier arm thus results in a pivoting of the entire parallelogram support and thus also of the microscope holder, which leads to a definite shift of the surgical microscope and of its main axis, and thus in design terms requires a readjustment each time.

Considerable effort was made in the past, and the creation of a stand of the species eliminates this problem.

U.S. Pat. No. 5,528,417 and EP-A-628290 indicate the manner in which microscope mounts held by parallelogram supports can be held in a perpendicular position even upon pivoting of the parallelogram support. This occurs by way of a lever-like brace on a vertical stand support (crank member), which is connected on the one hand via a tie rod to the microscope holder, and on the other hand to a non-pivotable stationary part of the stand. This construction has already been disclosed previously in the art in the context of a wide variety of designs, for example in the design of light sources held in the manner of a beam balance for desk lamps, or the like.

This known principle is therefore important for surgeons, since both the illumination and the optical main axis of the surgical microscope are intended to be oriented in one and the same direction onto the surgical site, even when the carrier arm is pivoted upward or downward. As indicated above, the previous approaches of the species provide for mechanical transfer mechanisms whose result is that a pivoting motion at the carrier arm automatically results in a correcting pivoting motion at the microscope carrier, so that every pivot angle of the carrier arm results in an identical pivot angle of the microscope carrier, and the optical axis or viewing direction of the microscope remains the same.

As mentioned above, however, in the event of changes in load these theoretically well-functioning designs must deal with the initially mentioned problem of deflection and, aside from that, with the disadvantage that in addition to the inherently already complex parallelogram support design, further mechanical components also become necessary. These not only contribute to an increase in weight, but also require tight tolerances, in dimensions and especially also in their multiple bearings, in order to enable precise operation.

Leaving entirely aside the problems referred to earlier regarding load changes on parallelogram supports of stands, there is also an additional disadvantageous phenomenon. This is the fact that a pivoting of the carrier arm out of the horizontal into a position oblique with respect thereto results, in a context of weight-related additional bending of the carrier arm, in a change in that bending as a function of the relative angular position of the carrier arm with respect to the perpendicular. Because carrier arms are usually oriented horizontally and in oblique positions with respect thereto, the result is that the bending and the compensation for pivot angles interact with one another, and overall only an imprecise alignment of the microscope holder or surgical microscope is possible.

DE 42 02 922 A 1 discloses a motorized stand for use with a surgical microscope. A defined positioning of the microscope is determined by means of several drive units with integrated angle transducers. One angle transducer is coupled to the drive motor of each drive unit. The other angle transducer is independent of the drive unit. Via corresponding control signals of a control unit to the individual drive units, a defined positioning of the microscope is possible.

The object of the present invention is thus to create a stand that avoids the disadvantages indicated above, that has components of the least possible weight and with accurate tolerances, and that therefore can be manufactured more simply and with less weight.

### SUMMARY OF THE INVENTION

The present invention includes an apparatus for defining an angular position that now no longer encompasses rods, bearings, and levers as is known and set forth above, but instead merely at least one motorized drive, in particular a positioning motor, that engages on the one hand on the carrier arm and on the other hand on the microscope holder, and in the context of operation defines the angular position between the microscope holder and the carrier arm in remotely controlled fashion and/or automatically. In a manner corresponding to conventional stand constructions, the pivotable carrier arm can preferably be weight-compensated by way of a support element, in particular via a bracing spring. This yields the advantages of smooth operation that are known per se, which however are even further intensified by the fact that the aforementioned smoothness-reducing factors of the existing art are eliminated, and a particularly smooth-operating stand is thus created.

This construction according to the present invention achieves the stated object. Not only does this novel construction result in ideal angle compensation that is entirely independent of deflection and the weight of the load or of the surgical microscope, and react in a consistently correct manner to any pivot angle of the load arm; it also results in elimination of the hitherto considerable mechanical components.

It thus results in a weight reduction, and also allows the parallelogram support, usual per se, to be replaced by simple tube or profile designs in which bending is deliberately accepted. The overall structure of the stand becomes lighter as a result, in particular also thanks to a reduction in the weight of balancing weights, which of course become lighter when the carrier arm itself becomes lighter. The construction according to the present invention furthermore makes possible a more compact and improved design. It further reduces complexity in the context of draping (covering with a sterile protective film).

The elimination of levers, rods, and bearings results in smoother movement of the surgical microscope when it is displaced by the surgeon. This relieves stress on the surgeon and therefore increases the safety of the surgical procedure.

The invention also makes possible, however, a very wide variety of novel effects. For example, a reproducible position of the microscope mount that deviates from a perpendicular can be arbitrarily selected. For certain applications it is thus possible to select specific angular positions that, in some circumstances, also enable compensations beyond the pivot-angle position of the carrier arm. The focus of the use of the present invention is, however, on the replacement of existing complex and heavy means for maintaining the position of the microscope holder parallel to the perpendicular with a simple, small mechanism in the form of a positioning motor.

According to a particular embodiment of the invention, such angle compensations can also be provided outside the pivot plane of the carrier arm, in particular orthogonally or transversely thereto. An additional drive is provided for such compensation measures. In a stand further developed in this fashion, the suspension system of the microscope holder can be spherical or can have two bearing axes arranged one above another.

The invention is usable independently of the type of weight compensation for the load, or in particular for the surgical microscope. The invention can be used both with stands constructed in the manner of a beam balance, and with gas-spring-braced carrier arms.

Advantageous further developments are presented in the Figures and the description of the Figures.

According to the invention, it is preferred if the pivotable carrier arm is embodied as a tubular or profile-shaped arm that is single or single-piece in section. The effect according to the present invention is then most effective. On the other hand, however, according to the present invention conventional parallelogram support stands could also be converted by simply removing the mechanism for pivot angle transfer and instead installing the positioning motor according to the present invention.

In a manner corresponding to conventional stand constructions, the pivotable carrier arm can preferably be weight-compensated by way of a support element, in particular via a bracing spring. This yields the advantages of smooth operation that are known per se, which however are even further intensified by the fact that the aforementioned smoothness-reducing factors of the existing art are eliminated, and a particularly smooth-operating stand is thus created.

In order to enhance the flexibility with which the surgical microscope can be used, provision can be made that the microscope holder is pivotable with respect to the carrier arm in a second plane, preferably orthogonally to the first plane, and that the angular position is definable in this second plane as well by means of another drive or another positioning motor (see FIGS. 11 and 12).

In order to ensure fail-safe operation, it is advantageous if the microscope holder is suspended with respect to the carrier arm in such a way that it automatically pivots or swings under its own weight, if the first and/or the other drive or motor is inactive, at least approximately into a stipulated angular position—in particular, close to the perpendicular—or is at least subject to a torque in the direction of that close-to-perpendicular position in order to reach that position.

Leaving aside any fail-safe operation, the result of an improved further development is that the microscope holder is suspended with respect to the carrier arm in such a way that its center of gravity is located to the side of a perpendicular through the suspension, in particular to the side of a pivot shaft (microscope holder pivot shaft), and/or to the side of a rotation axis of the microscope holder, and in the operating state the first and/or the second drive or positioning motor automatically absorbs the resulting torque in order to pivot the microscope holding apparatus into the desired angular position, preferably into the perpendicular. What is achieved thereby is that the first and/or the other positioning motors are under less load or can require less energy consumption, and accordingly can also be physically small.

The configuration according to the present invention having angle-compensating first and/or other positioning motors moreover advantageously allows the microscope holder to be suspended with respect to the carrier arm with a clearance that, in the operating state, is compensated for or set to zero clearance by the first and/or the other drive or positioning motor. This allows an economical embodiment of the bearings, while the precision of the stand is nevertheless sufficient.

The construction according to the present invention is simplified if a control system is provided which defines the definition of the angular position(s) as a function of the pivot-angle position of the carrier arm. This control system need not obligatorily be an independent control system, for example a control chip directly in the region of the first and/or the other positioning motor(s); it can also be integrated, in hardware or software, into the computer that is normally present in the stand or the surgical microscope.

Complete automation is made possible if a measurement apparatus, in particular a pivot/tilt sensor, is provided, which, in the operating state, triggers the control system or the first positioning motor and/or the other positioning motor to define the angular position(s) as a function of the pivot-angle position of the carrier arm.

A pivot/tilt sensor of this kind is preferably attached at the distal end of the carrier arm or on the microscope holder itself, in order to ascertain in situ the actual position of the carrier arm or of the microscope holder.

A plurality of sensors known per se are available in the context of the invention for this task, for example: tilt sensor, height sensor, angle sensor, spatial coordinate sensor (e.g. IR-assisted), or the like.

At least one electrical drive from the following non-exhaustive list is appropriate as a motorized drive for the first and/or the other positioning motor: electric motor, geared motor, linear motor, rotary stepping motor, electroactive polymers (EAP). Besides these, the drives can of course also be hydraulic or pneumatic.

Advantages result if the drive or the first and/or the second positioning motor is/are embodied in self-locking fashion, so that any power failures or disruptions in the supply of power to said drives cannot result in a displacement of the surgical microscope.

According to a particular embodiment, the drive or the first and/or the second positioning motor can also be embodied in decouplable fashion in the manner of a releasable brake or clutch, in order to allow arbitrary displacement of the surgical microscope.

The invention results in any event in a device on the stand of a surgical microscope for ensuring a constantly perpendicular position of the microscope carrier or of the microscope.

For purposes of the invention, the depiction with a microscope carrier and surgical microscope are merely exemplary. A stand according to the present invention can be successfully used for other types of load.

Stands for surveying, film, photography, or the like thus also fall within the range of the present invention.

Another advantageous further development of the invention results if the carrier arm itself is embodied in modifiable-length fashion, and is shiftable lengthwise or telescopically extendable with respect to the pivot bearing bracket (see FIG. 10). The result of this construction, in combination with the advantages of the invention that have already been recited above, is not only that upward pivoting of the carrier arm can be compensated for, according to the present invention, with respect to the tilt of the microscope holder, but also that the location of the main axis of the surgical microscope can remain at the same distance from the stand body or from the stand axis.

This is achieved, for example, by the fact that a pivot motion out of the horizontal automatically results in an elongation of the carrier arm, in the same ratio at which the distance would be shortened by the pivoting.

Further advantages, features, and details of the invention are evident from the description below, in which exemplifying embodiments of the invention are described with reference to the drawings. Features mentioned in the specification may be essential to the invention each individually of themselves or in any combination.

The list of reference characters is a constituent of the disclosure. The Figures are described in continuous and overlapping fashion. Identical reference characters denote identical components. Reference characters having different indices indicate functionally identical or similar components.

### BRIEF DESCRIPTION OF THE DRAWINGS

FIG. 1 shows a partly assembled upper part of a stand having a carrier arm 4a of a first embodiment, of a stand according to the present invention;

FIG. 2 shows the construction according to FIG. 1 from above;

FIG. 3 shows the construction of FIG. 1 obliquely from the front;

FIG. 4 shows the construction of FIG. 1 obliquely from below;

FIG. 5 shows the construction of FIG. 1 obliquely from behind;

FIG. 6 shows the construction of FIG. 5 with carrier arm 4a removed;

FIG. 7 shows the construction of FIG. 6 with bearing bracket 16 further disassembled;

FIG. 8 shows the construction of FIG. 7 further disassembled;

FIG. 9 shows an enlarged detail of the positioning drive for the microscope holder of FIG. 1;

FIG. 10 shows, in section, a variant having a telescopically extendable two-part carrier arm 4b, 4c;

FIG. 11 is a view from the front of a further development having a different positioning motor 22;

FIG. 12 shows a detail of the construction according to FIG. 11;

FIG. 13 shows a variant having a pivotable vertical support 40; and

FIG. 14 shows a construction from the existing art.

### DETAILED DESCRIPTION

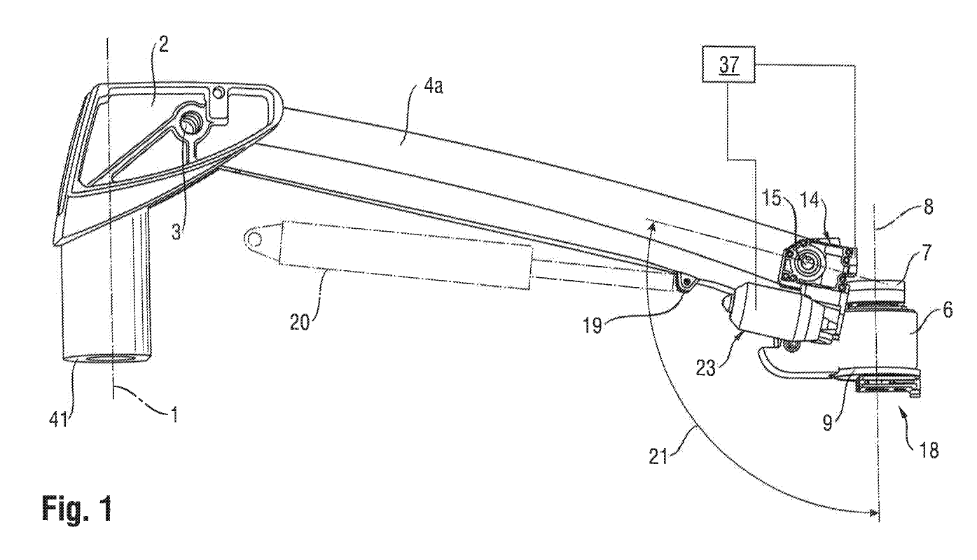

FIG. 1 shows a partly assembled upper part of a stand having a carrier arm 4a that is held on a carrier arm bearing shaft 3 in a pivot bearing bracket 2.

Pivot bearing block 2 is mounted, rotatably around a stand axis 1, on a vertical stand part 41 (depicted only in part).

Carrier arm 4a is braced by way of a bracing spring 20 with respect to pivot bearing bracket 2. The end of bracing spring 20 toward the pivot bearing bracket is symbolically depicted as being free-floating. Any articulation points known per se on pivot bearing bracket 2, or also on vertical stand part 41, are nevertheless available in practice for this.

At the distal end of bracing spring 20, it is fastened pivotably to an articulation flange 19.

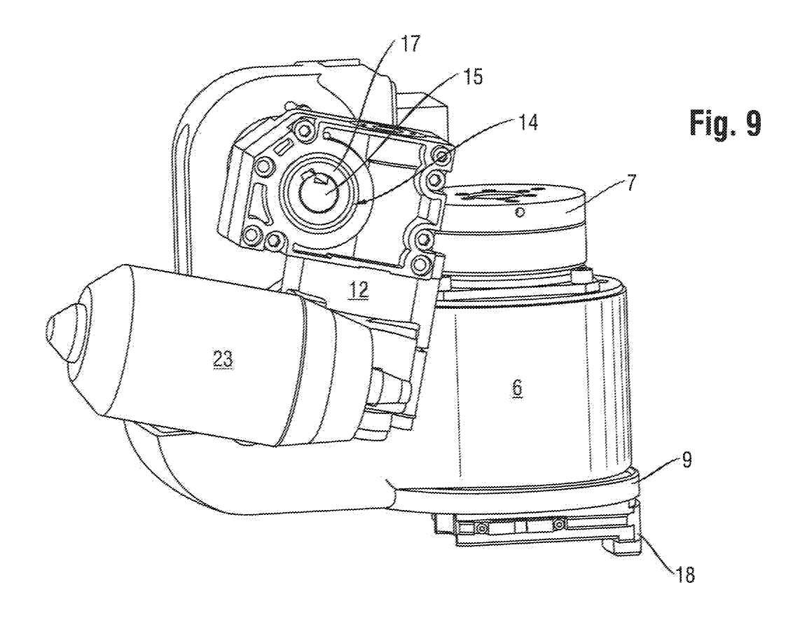

Located at the distal end of carrier arm 4a is a microscope holder pivot shaft 15 that carries a microscope holder 6. The latter symbolically shows a rotation axis 8 for the surgical microscope that can be connected to a microscope interface 18 (FIG. 9). Microscope interface 18 is located on a pivot bearing 9 for the surgical microscope, which can be immobilized by means of a brake 7.

In order for the surgical microscope and its microscope holder 6 to be adjusted in terms of angle with respect to carrier arm 4a and/or with respect to the perpendicular, a first positioning motor 23 is provided which performs, via a right-angle drive train 14, tilt adjustment of microscope holder 6 relative to the perpendicular, or ensures the perpendicular position thereof. Angular position 21 is fundamentally not relevant.

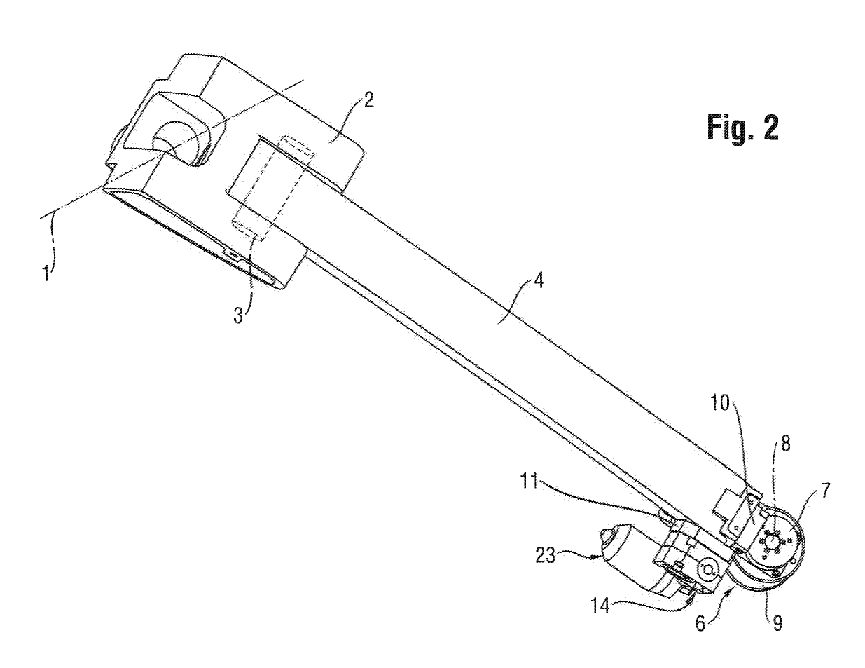

FIG. 2 moreover shows a pivot/tilt sensor 10. This pivot/tilt sensor is installed on microscope carrier 6. Its purpose is to measure any deviation from the vertical position and to generate corresponding positioning instructions by means of which first positioning motor 23 is driven in order to establish the vertical position. An adapter flange 11 for right-angle drive train 14 is depicted.

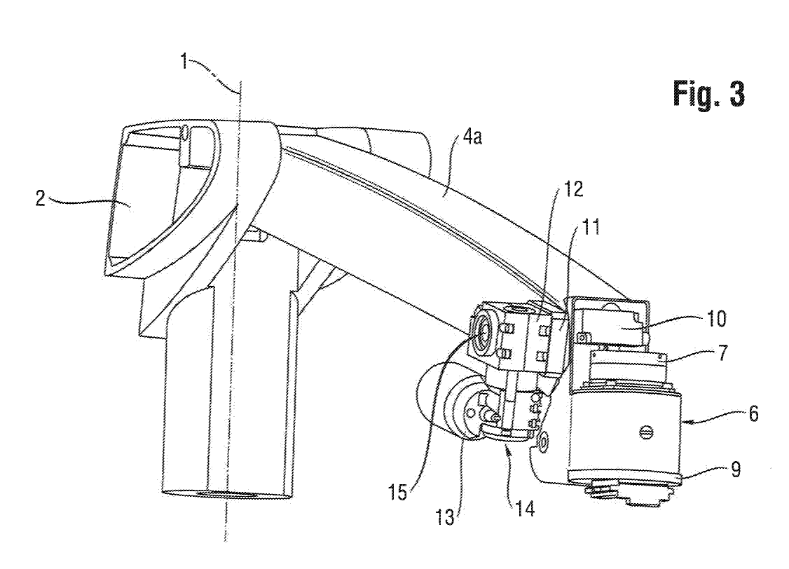

In FIG. 3, motor housing 13 of first positioning motor 23 is also marked.

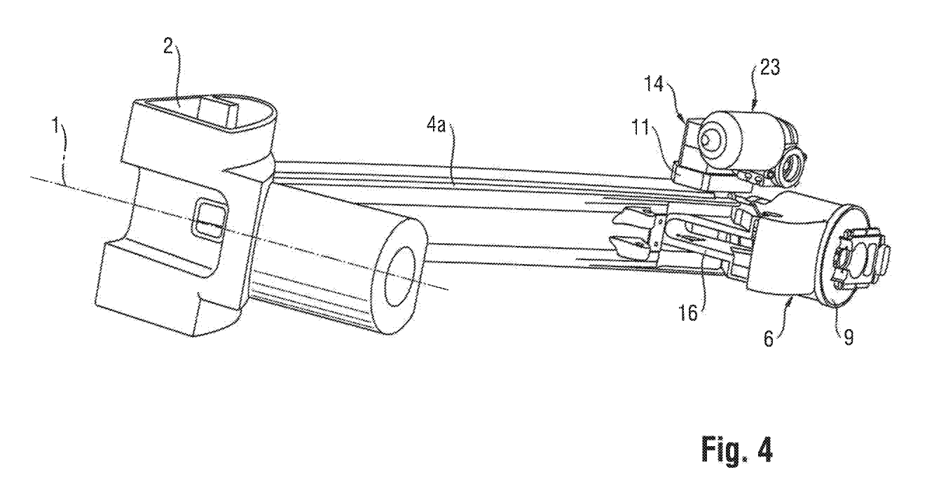

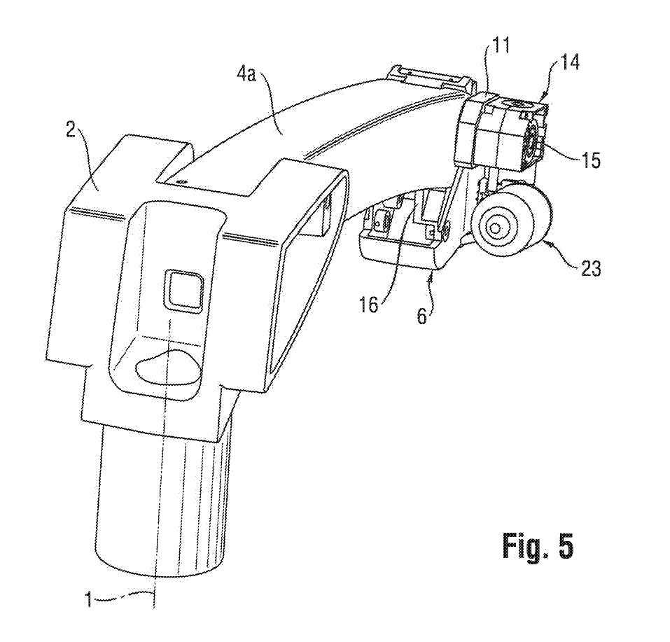

FIGS. 4 and 5 show the manner in which a bearing bracket 16 of microscope holder 6 on the underside of carrier arm 4a cooperates with the latter in order to ensure lateral guidance. Bearing bracket 16 is held by microscope holder pivot shaft 15.

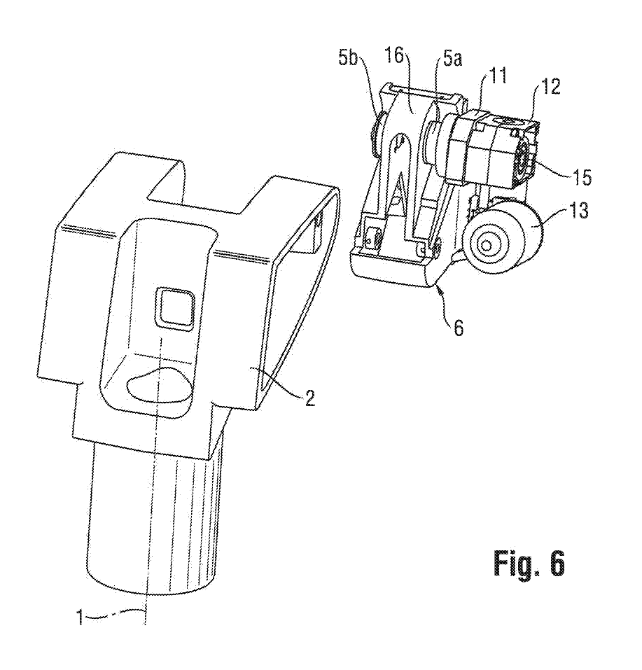

FIG. 6 shows in detail the manner in which, in this exemplifying embodiment, microscope holder pivot shaft 15 is held by means of support bearings 5a and 5b in carrier arm 4a (not depicted here), and on the other hand receives microscope holder 6 on its bearing bracket 16.

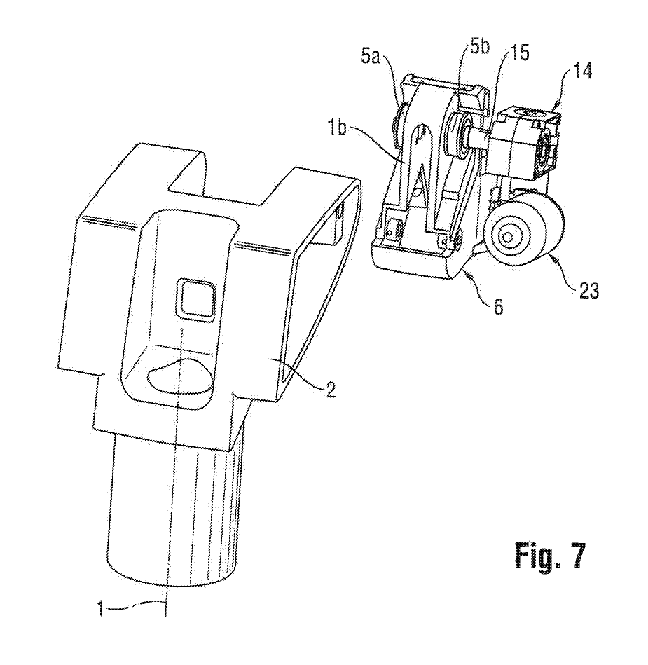

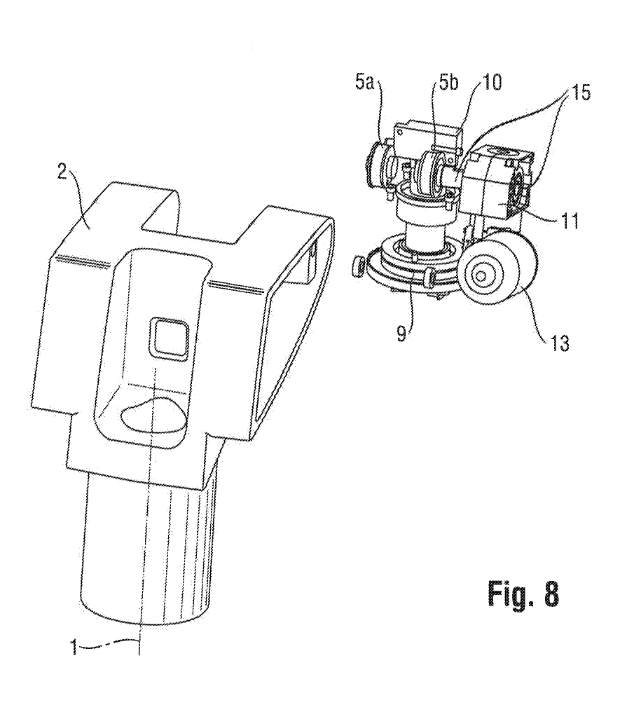

The further depictions of FIGS. 7 and 8 explain the further inner life of this construction. Particularly evident in FIG. 8 is the separated-out microscope holder pivot shaft 15 that does not pass through bearings 5a and 5b.

FIG. 9 provides a better view of hollow drive shaft 17 that ensures energy transfer between right-angle drive train 14 and the carrier arm. The right-angle drive train together with first positioning motor 23 is installed at the distal end of carrier arm 4a. An actuation of first positioning motor 23 produces, via the right-angle drive train, a rotary motion of microscope holder pivot shaft 15 which nonrotatably entrains bearing bracket 16, and thus causes a change in angular position 21.

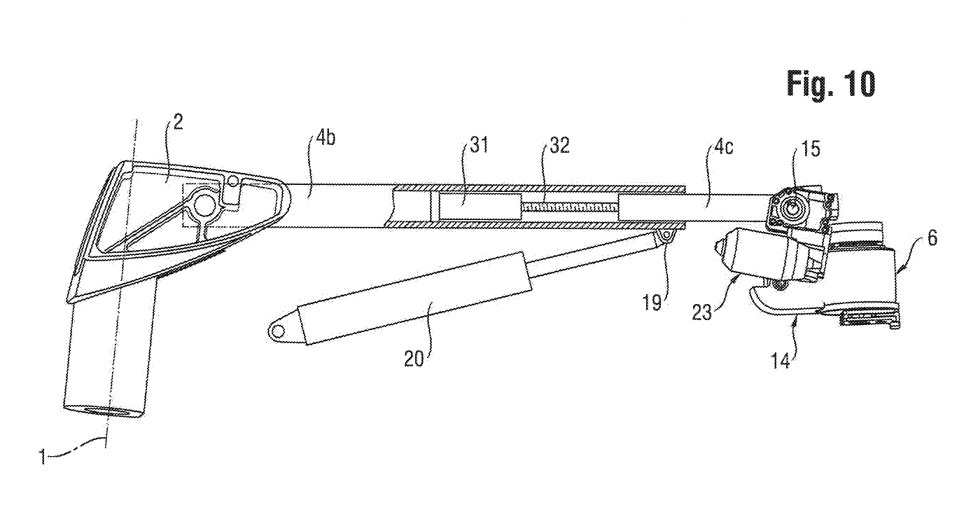

FIG. 10 shows a variant having a two-part carrier arm 4b (outer) and 4c (inner). A telescope motor 31 can shift the two carrier arm parts 4b and 4c with respect to one another via a telescope spindle 32, with the result that the carrier arm length can be adjusted. Although not shown in more detail, bracing spring 20 either also has a telescope elongation capability activatable in parallel, or is adjusted in terms of its spring characteristic curve so that it automatically compensates for the different bracing force depending on the length of the carrier arm.

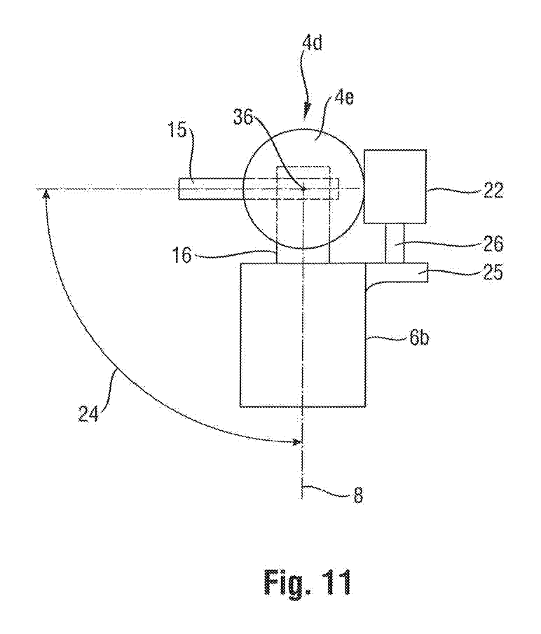

FIG. 11 shows a modified carrier arm 4d (concealed) and 4e, from its end face.

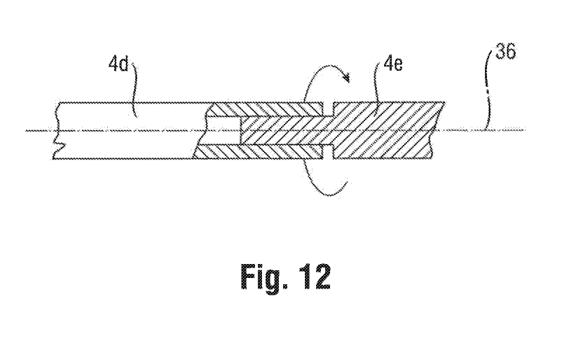

In the construction according to FIGS. 11 and 12, the carrier arm is once again split in two (as shown in FIG. 12, rear 4d and front 4e), but this time not in order to enable a lengthwise displacement but in order to enable a pivoting motion of microscope holder 6 around a rotation axis 36.

Another positioning motor 22, which can provide positioning feed via a positioning member 26 and a bracing surface 25 on microscope holder 6b, is symbolically depicted.

FIG. 12 symbolically shows a lengthwise section through the connection of rotatable carrier arm parts 4d and 4e, in which context carrier arm part 4e also carries microscope holder 6b.

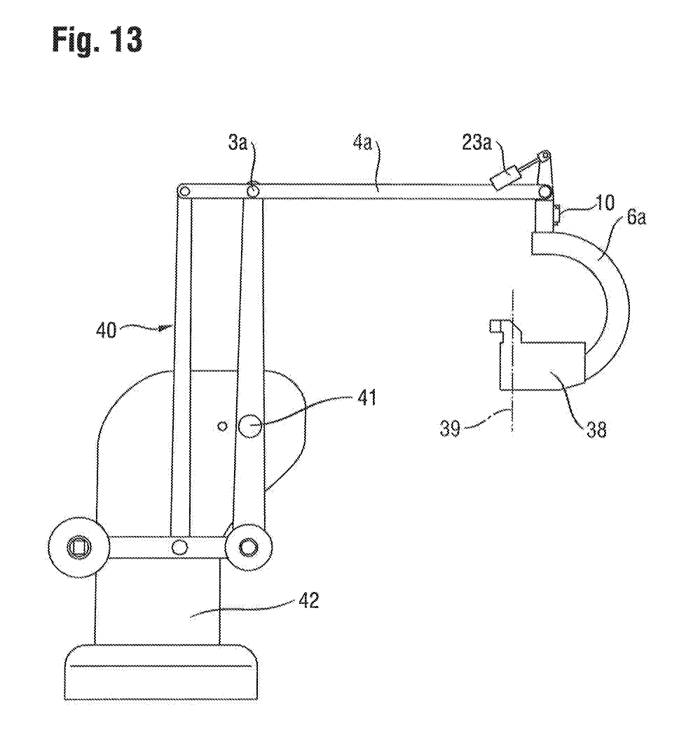

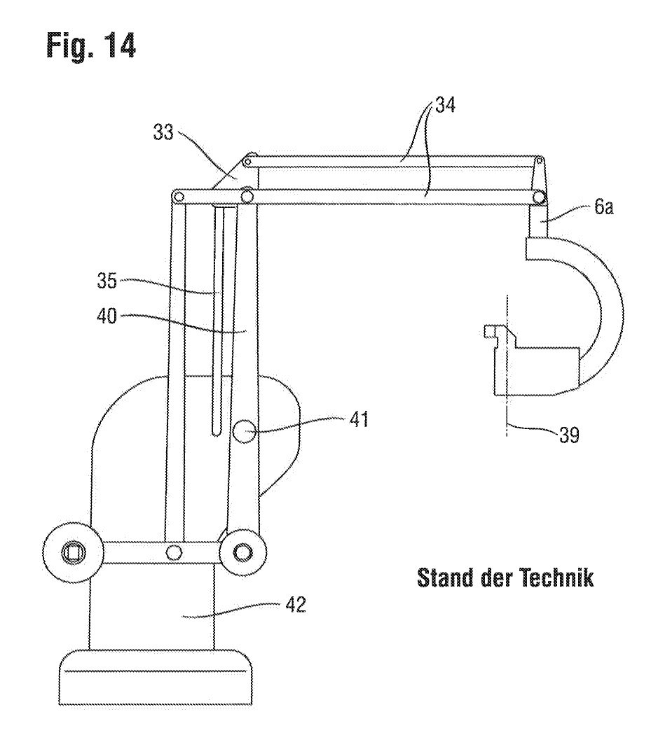

FIG. 13 shows a variant having a pivotable vertical support 40 that is constructed, in accordance with the existing art, as a parallelogram support. It is pivotable around a shaft 41. In contrast to the existing art according to FIG. 14, however, carrier arm 4a is embodied here in one piece, whereas according to FIG. 14 it was again constructed as a parallelogram support. Another first positioning motor 23a, depicted here as a spindle drive, once again ensures the correct angular position of microscope carrier 6a relative to the perpendicular or relative to carrier arm 4a.

FIG. 14 symbolically illustrates the previous existing art for compensating for pivot-angle position on the microscope holder. The upper rod in parallelogram support 34, transfer part (crank member) 33, and tie rod 35 that is perpendicular in the image and is connected at its proximal end to stand body 42, cause microscope carrier 6a always to remain in a perpendicular position regardless of the pivot state of parallelogram support 34 (carrier arm) or the pivot state of vertical support 40.

The invention is not to be limited to the specific embodiments disclosed, and modifications and other embodiments are intended to be included within the scope of the invention.

### LIST OF REFERENCE CHARACTERS

1 Stand axis
2 Pivot bearing bracket
3, 3a Carrier arm bearing shaft
4, 4a, 4b Carrier arm, outer telescoping arm
4c Telescoping carrier arm, inner
4d Outer carrier arm with rotary bearing
4e Inner carrier arm in rotary bearing
5, 5a, 5b Support bearing
6, 6a, 6b Microscope holder
7 Brake for rotary motion of surgical microscope
8 Rotation axis for surgical microscope
9 Rotary bearing for surgical microscope
10 Pivot/tilt sensor
11 Adapter flange
12 Drive train housing
13 Motor housing
14 Right-angle drive train
15 Microscope holder pivot shaft
16 Bearing bracket of microscope holder
17 Hollow drive shaft
18 Microscope interface
19 Articulation flange for bracing spring
20 Bracing spring
21 Angular position of microscope holder relative to carrier arm 4
22 Other positioning motor
23, 23a First positioning motor
24 Angular position of microscope holder relative to horizontal or relative to microscope holder pivot shaft 15
25 Bracing surface
26 Positioning member
31 Telescope motor
32 Telescope spindle
33 Crank member
34 Parallelogram support
35 Tie rod
36 Rotation axis
37 Control system
38 Surgical microscope
39 Optical main axis of surgical microscope
40 Pivotable vertical support
41 Shaft
42 Stand body

What is claimed is:

1. A stand for a surgical microscope having an optical main axis, comprising:
a pivotable carrier arm (4) mounted in a pivot bearing bracket (2);
a microscope holder (6), pivotable in a first plane on the carrier arm (4), at the distal end of the carrier arm (4) for reception of the surgical microscope, the microscope holder (6) having a definable angular position (21; 24) with reference to the carrier arm (4) in order thereby to adjust the relative angular position of the main axis with reference to the perpendicular; and
an apparatus (10-17, 23) configured to define said angular position (21; 24) having at least one positioning motor (23; 23a; 22) that engages the carrier arm (4) and the microscope holder (6), and during operation defines the angular position (21; 24) in remotely controlled fashion and/or automatically;
wherein the pivotable carrier arm (4) is a single part or single piece, and is tubular or profile-shaped in section;
wherein the pivotable carrier arm (4) is weight-compensated via a bracing spring (20).

2. The stand according to claim 1, wherein the microscope holder (6) is pivotable with respect to the carrier arm (4) in a second plane and the angular position (24) is definable in this second plane as well by means of another drive or positioning motor (22).

3. The stand according to claim 2, wherein the second plane is orthogonal to the first plane.

4. The stand according to claim 1, wherein the microscope holder (6) is suspended with respect to the carrier arm (4) in such a way that it automatically pivots or swings under its own weight, if the first and/or the other drive or positioning motor (23; 23a; 22) is inactive, at least approximately into a stipulated angular position or is at least subject to a torque in the direction of that close-to-perpendicular position in order to reach that position.

5. The stand according to claim 4, wherein the stipulated angular position is close to the perpendicular.

6. A stand for a surgical microscope having an optical main axis, comprising:
a pivotable carrier arm (4) mounted in a pivot bearing bracket (2);
a microscope holder (6), pivotable in a first plane on the carrier arm (4), at the distal end of the carrier arm (4) for reception in particular of the surgical microscope, the microscope holder (6) having a definable angular position (21; 24) with reference to the carrier arm (4) in order thereby to adjust the relative angular position of the main axis with reference to the perpendicular; and
an apparatus (10-17, 23) for defining said angular position (21; 24) having at least one positioning motor (23; 23a; 22) that engages on the one hand on the carrier arm (4) and on the other hand on the microscope holder (6), and in the context of operation defines the angular position (21; 24) in remotely controlled fashion and/or automatically;
wherein the microscope holder (6) is suspended with respect to the carrier arm (4) in such a way that its center of gravity is located to the side of a perpendicular through the suspension, in particular to the side of a microscope holder pivot shaft (15), and/or to the side of a rotation axis (36) of the microscope holder (6), and in the operating state the first and/or the second drive or positioning motor (23; 23a; 22) automatically absorbs the resulting torque in order to pivot the microscope holding apparatus into the desired angular position (21; 24), preferably into the perpendicular.

7. The stand according to claim 6, wherein the pivotable carrier arm (4) is a single part or single piece, and is tubular or profile-shaped in section.

8. The stand according to claim 7, wherein the pivotable carrier arm (4) is weight-compensated via a bracing spring (20).

9. The stand according to claim 6, wherein the microscope holder (6) is pivotable with respect to the carrier arm (4) in a second plane, and the angular position (24) is definable in this second plane as well by means of another drive or positioning motor (22).

10. The stand according to claim 9, wherein the second plane is orthogonal to the first plane.

11. The stand according to claim 6, wherein the microscope holder (6) is suspended with respect to the carrier arm (4) in such a way that it automatically pivots or swings under its own weight, if the first and/or the other drive or positioning motor (23; 23a; 22) is inactive, at least approximately into a stipulated angular position or is at least subject to a torque in the direction of that close-to-perpendicular position in order to reach that position.

12. The stand according to claim 11, wherein the stipulated angular position is close to the perpendicular.

13. The stand according to claim 6, wherein the microscope holder (6) is suspended with respect to the carrier arm (4) with a clearance that, in the operating state, is compensated for or set to zero clearance by the first and/or the other drive or positioning motor (23; 23a; 22).

14. The stand according to claim 6, further comprising a control system (37) configured to define the definition of the angular position(s) (21; 24) as a function of the pivot-angle position of the carrier arm (4).

15. The stand according to claim 14, further comprising a pivot/tilt sensor (10), which, in the operating state, triggers the control system (37) or the first positioning motor (23; 23a) and/or the other positioning motor (22) to define the angular position(s) (21; 24) as a function of the pivot-angle position of the carrier arm (4).

16. The stand according to claim 6, wherein the pivot/tilt sensor is at least one of the following sensors: tilt sensor, height sensor, angle sensor, spatial coordinate sensor.

17. The stand according to claim 6, wherein the at least one positioning motor (23; 23a; 22) is at least one of the following: electric motor, geared motor, linear motor, rotary stepping motor, electroactive polymers (EAP).

18. The stand according to claim 6, wherein the drive or the first and/or the other positioning motor (23; 23a; 22) is self-locking.

19. The stand according to claim 6, wherein the drive or the first and/or the other positioning motor (23; 23a; 22) is decouplable via a releasable brake.

20. A stand for a surgical microscope having an optical main axis, comprising:
a pivotable carrier arm (4) mounted in a pivot bearing bracket (2);
a microscope holder (6), pivotable in a first plane on the carrier arm (4), at the distal end of the carrier arm (4) for reception in particular of the surgical microscope, the microscope holder (6) having a definable angular position (21; 24) with reference to the carrier arm (4) in order thereby to adjust the relative angular position of the main axis with reference to the perpendicular; and
an apparatus (10-17, 23) for defining said angular position (21; 24) having at least one positioning motor (23; 23a; 22), that engages on the one hand on the carrier arm (4) and on the other hand on the microscope holder (6), and in the context of operation defines the angular position (21; 24) in remotely controlled fashion and/or automatically;
wherein the pivotable carrier arm (4) is a single part or single piece, and is tubular or profile-shaped in section;
wherein the pivotable carrier arm (4) is shiftable lengthwise or telescopically extendable with respect to the pivot bearing bracket (2).
